(19) United States
(12) Patent Application Publication
(10) Pub. No.: US 2024/0119306 A1
(43) Pub. Date: Apr. 11, 2024

(54) INTEROPERABLE PRIVACY-PRESERVING DISTRIBUTED MACHINE LEARNING METHOD FOR HETEROGENEOUS MULTI-CENTER DATA

(71) Applicant: Cipherome, Inc., San Jose, CA (US)

(72) Inventors: Samuel Kim, La Palma, CA (US); Min Sang Kim, Sunnyvale, CA (US); Won Joon Yun, Seoul (KR)

(21) Appl. No.: 18/471,112

(22) Filed: Sep. 20, 2023

Related U.S. Application Data
(60) Provisional application No. 63/409,291, filed on Sep. 23, 2022.

(51) Int. Cl. G06N 3/098

(52) U.S. Cl. CPC G06N 3/098

(57) ABSTRACT

A learning system deploys, to one or more client devices, modules to be deployed in a learning environment of a respective client node. The learning environment of a respective client node may include modules for the client device (or client node) to collaborate with the central learning system and other client nodes via a distributed learning (e.g., federated learning, split learning) framework. In one embodiment, the learning system deploys an interoperable distributed learning environment for training a neural network encoder which can be used in heterogenous datasets to transform the heterogenous datasets across different institutions or entities into a common latent feature space. After training, the learning system receives data instances including a set of features and labels from different client nodes and trains a task neural network model configured to receive features in the latent space and generate an estimated label from the received data instances.

### CROSS-REFERENCE TO RELATED APPLICATIONS

This application claims the benefit of U.S. Provisional Application No. 63/409,291, filed on Sep. 23, 2022, which is incorporated herein in its entirety.

### TECHNICAL FIELD

This disclosure relates generally to artificial intelligence (AI) and machine-learning (ML) applications, and particularly to distributed learning in the context of electronic health records.

### BACKGROUNDS

Healthcare data are typically fragmented and private. Different medical institutes own their own electronic health records of patients, and the data are difficult to share across institutes because of privacy concerns. Federated learning allows multiple data owners to collaborate with each other to train a master machine-learning model without exposing individual datasets that have privacy concerns. Federated learning can be adapted for application to healthcare data to mitigate issues with distributed machine learning approaches where different medical institutes share models and anonymized data rather than raw data, while solving technical issues such as consolidating derivatives from various client devices, imbalance in data, network latency and security. However, often times, there is technical difficulty in coordinating the learning process across multiple client devices. Moreover, the data in individual institutes are heterogenous data distributions that are associated with their own data structures and schema. This leads even semantically identical or similar concepts to be represented significantly differently and makes it difficult to work with in the context of multi-center data.

### SUMMARY

A learning system deploys, to one or more client devices, modules to be deployed in a learning environment of a respective client node. The learning environment of a respective client node may include modules for the client device (or client node) to collaborate with the central learning system and other client nodes via a distributed learning (e.g., federated learning, split learning) framework. In one embodiment, the learning system deploys an interoperable distributed learning environment for training a neural network encoder which can be used in heterogenous datasets to transform the heterogenous datasets across different institutions or entities into a common latent feature space. After training, the learning system receives data instances including a set of features and labels from different client nodes and trains a task neural network model configured to receive features in the latent space and generate an estimated label from the received data instances.

In this manner, the learning system allows many institutions to effectively participate in the distributed learning framework by coordinating training of the encoder that maps client data to a common latent space. When features generated in this latent space are provided to the learning system along with training labels, the features and labels can be used by the learning system to train a task neural network model without exposing the raw data of the client node that provided the data. Moreover, a separate extract, transform, and load (ETL) module may not be necessary.

Specifically, in one embodiment, for one or more iterations, the learning system performs federated learning with one or more client nodes. A client node may be associated with, for example, a hospital, a medical institute, a healthcare-related entity. The learning system provides, to each client node, a global model for a current iteration to the client node for training using client data. The global model includes at least an autoencoder and a task neural network model. In one instance, an encoder of the autoencoder is configured to receive a set of inputs and generate a feature in latent space and a decoder of the autoencoder is configured to receive the feature and reconstruct the set of inputs. The task neural network model is configured to receive the feature and generate an estimated label for a given task.

The learning system receives, from each client node, the trained parameters of the global model from the client node. The trained parameters of the global model are trained using at least a subset of the client data for the current iteration. The learning system aggregates the trained parameters of the global model received from the one or more client nodes. The learning system receives, from each client node, one or more data instances. A data instance includes a feature and a label for the data instance. The feature may be generated by applying the encoder for the client node to another set of inputs of the client data. The learning system trains another task neural network model using the data instances received from the one or more client nodes.

During inference, an institution may obtain a new set of inputs and apply the trained encoder to the new set of inputs to generate a feature for the inputs in the latent space. The client node associated with the institution may provide the feature for the inputs to the learning system. The learning system may apply the trained task neural network model to the feature to generate an estimated label for the new set of inputs without exposure of the raw data. The learning system may provide the estimated labels to the client node as a response.

### BRIEF DESCRIPTION OF DRAWINGS

Figure (“FIG.”) 1 illustrates a system environment for interoperable distributed learning, according to one embodiment.

FIG. 2 illustrates a pipeline of the federated learning (FL) phase of the distributed learning framework, according to one embodiment.

FIG. 3 illustrates a pipeline of the split learning (SL) phase of the distributed learning framework, according to one embodiment.

FIG. 4 illustrates a block diagram of an architecture of a learning environment within a client node, according to one embodiment.

FIG. 5 is a training pipeline of a global model executed by a client node within a distributed learning framework, according to one embodiment.

FIG. 6 illustrates splitting of the encoder and task neural network model for the global model, according to one embodiment.

FIG. 7 illustrates comparisons of a latent space and a reconstructed data space with different federated learning frameworks trained with a task loss and/or a reconstruction loss, according to one embodiment.

FIG. 8 is a training pipeline of a server-side task model executed by a distributed learning module of a learning system, according to one embodiment.

FIG. 9 is an overall pipeline of the distributed learning framework including the FL phase, the SL phase, and the validation phase, according to one embodiment.

FIG. 10 is an example flowchart for distributed training of a global model and a server-side task model, according to one embodiment.

The figures depict various embodiments of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Disclosed is a configuration (including a system, a process, as well as a non-transitory computer readable storage medium storing program code) for training of a global model on one or more client devices and training of a task neural network model in an interoperable distributed learnings environment.

### Overview

FIG. 1 illustrates a system environment 100 for interoperable distributed learning, according to one embodiment. The system environment 100 shown in FIG. 1 comprises one or more client nodes 116A, 116B, and 116C, a learning system 110, and a network 150. The learning system 110 in one embodiment also includes a distributed learning module 118 and a learning store 112. In alternative configurations, different and/or additional components may be included in the system environment 100 and embodiments are not limited hereto.

The learning system 110 (e.g., the distributed learning module 118) deploys, to one or more client nodes 116, modules to be deployed in a learning environment of a respective client node. In one embodiment, learning system 110 described herein may allow the client nodes 116 to perform distributed machine learning without sharing privacy-sensitive information that are stored and managed in respective client nodes. In other words, the learning system 110 may enable a distributed learning framework that is interoperable, yet privacy-preserving so that participating institutes (e.g., corresponding to the client nodes) perform various research using not only their own data but also other institutes' data without compromising privacy of the other institutes' data.

In one embodiment, the distributed machine learning framework orchestrated by the learning system 110 is responsible for training a master machine-learning model used for a variety of inference tasks, for example, health event classification, natural language processing (NLP), image processing, video processing, or audio processing applications in the context of, for example, healthcare applications. The machine-learning model is trained across one of more client nodes 116, and may be configured as artificial neural networks (ANNs), recurrent neural networks (RNNs), deep learning neural networks (DNNs), bi-directional neural networks, transformers, classifiers such as support vector machines (SVMs), decision trees, regression models such as logistic regression, linear regression, stepwise regression, generative models such as transformer-based architectures including GPT, BERT, encoder-decoders, or variational autoencoders, and the like.

In particular, a significant difficulty for distributed machine learning using privacy-sensitive health or medical data is that data may generally be fragmented and private for each institution, as different health and medical institutes locally store their own electronic health records of patients, and the data are difficult to share across institutes because of privacy concerns. Moreover, each institution may store the data according to their own data schema and may be heterogenous with respect to the types of fields, data distribution, and the like. In this situation, the severe degradation of interoperability of models may occur.

For example, an institution (e.g., institution A) may classify diseases and encode data according to the International Statistical Classification of Diseases (ICD-10), another institution (e.g., institution B) may classify diseases and encode data according to the Korean Standard Classification of Diseases (KCD5), and another institution (e.g., institution C) may classify diseases and encode data according to the Canadian Coding Standards. However, a machine-learning model for a particular institution is not interoperable with data from other institutions because of heterogeneity.

While a federated learning (FL) mechanism can address this problem by providing a decentralized learning framework including local clients and a server. A client trains a machine-learning model with its own local data and transmits the gradients to the server, while the server constructs a global model with various aggregating methods. A FL mechanism may enable the global model to operate datasets from more than one client and with privacy-preserving effects. However, often times, datasets from individual institutes are heterogeneous in data distributions and have different syntactic structures. This may lead to a significant performance degradation in federated learning.

Thus, in one embodiment, a learning system 110 deploys an interoperable distributed learning environment 100 for building a neural network-based encoder, which can be used in heterogeneous datasets either in the data distribution and/or syntactic context. In one embodiment, the learning system 110 performs a FL phase, a SL phase, and a validation phase to train a task-based neural network model that is trained in conjunction with data from the one or more client nodes 116. During the FL phase, the learning system 110 provides copies of global models to the client nodes 116. In one instance, the global model includes a neural network encoder, and a task neural network model. The neural network encoder is configured to receive a set of data inputs and generate a latent representation of the data inputs in the latent space. In one instance, the global model includes an autoencoder architecture (e.g., variational autoencoder (VAE)) configured with an encoder and decoder, such that the encoder is trained in conjunction with the decoder. However, it is appreciated that the neural network encoder can be any neural network model that is able to map the set of data inputs into a latent space, such as an embedding model. The learning system 110 performs one or more iterations to aggregate and update parameters of the encoder and task neural network model received from the client nodes 116. During the SL phase, the learning system 110 receives features (encoded using the trained encoders) and labels from the client nodes 116 and trains a server-side task model.

In this manner, the learning system 110 allows many institutions to effectively participate in the distributed learning framework by coordinating the training of the encoder that maps client data to a common latent space. When features generated in this latent space are provided to the learning system 110 along with the training labels, the features and labels can be used to train a task neural network model without exposing the raw data of the client node 116 that was the source of the data. Moreover, a separate extract, transform, and load (ETL) module may not be necessary because the parameters of the encoder are learned to convert input data in different schema to a common latent space that is effective for downstream tasks.

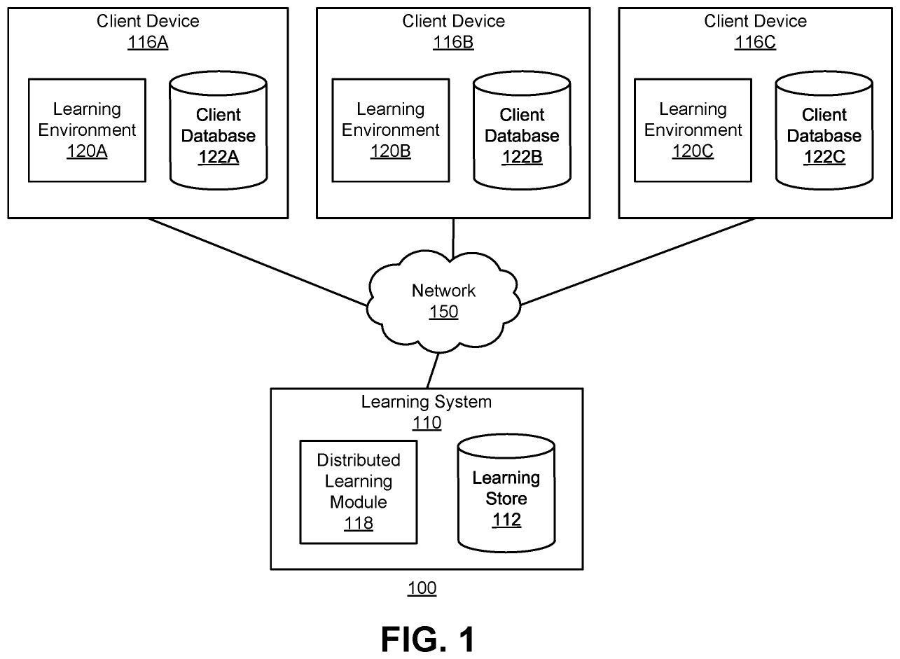

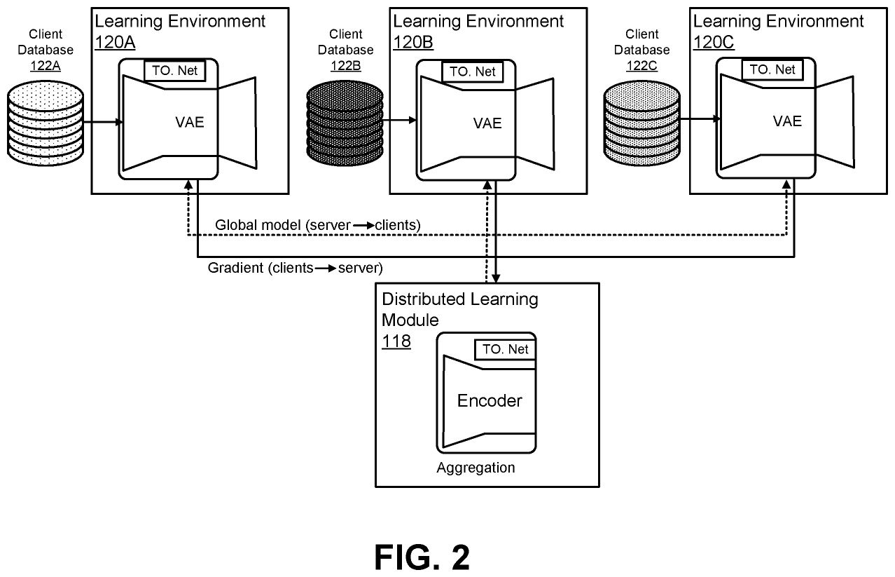

FIG. 2 illustrates a pipeline of the FL phase of the distributed learning framework, according to one embodiment. Specifically, during an FL phase of the pipeline, the distributed learning module 118 coordinates federated learning of the global model at each client node 116 in conjunction with other client nodes 116 across one or more iterations. The objective of the encoder is to transform the heterogeneous datasets into a representation in the latent feature space in a manner that is able to reconstruct the original data distribution while optimizing for a task that the task neural network model is designed to perform.

At a current iteration, the distributed learning module 118 provides a copy of a global model to each client node 116. In the example shown in FIG. 2, a copy of a global model including a variational autoencoder (VAE) and a task neural network model is provided to each of the learning environment 120A of client node 116A, the learning environment 120B of client 116B, and the learning environment 120C of client node 116C. As an example, when trained, an encoder is configured to receive a set of inputs (e.g., patient's medical history) from client data and generate a feature representing the set of inputs in the latent space. A task neural network model is coupled to receive the feature and generate an estimated label (e.g., predicted likelihood of adverse drug reaction (ADR) for patient).

After local training, the distributed learning module 118 receives a trained encoder and task neural network model from each client node 116 that is trained using client data stored at the client node 116. In the example shown in FIG. 2, updates (e.g., backpropagation gradients) to the parameters of a first trained encoder and a first task neural network model are received from client node 116A, updates to the parameters of a second trained encoder and a second task neural network model is received from client node 116B, and updates to parameters of a third trained encoder and third task neural network model are received from client node 116C for the current iteration.

The distributed learning module 118 aggregates the parameters of the encoder and task neural network models received from the client nodes 116 to generate an aggregated global model for the current iteration. In the example shown in FIG. 2, the distributed learning module 118 may aggregate trained parameters of the encoders and task neural network models received from the client nodes 116A, 116B, 116C via, for example, a statistic such as average, sum, median, and the like. In another example, the distributed learning module 118 may aggregate the updates to parameters that were obtained across different client nodes 116, aggregate the updates, and apply the aggregated updates to update parameters of the encoder and task neural network model of the global model.

For the next communication round, the distributed learning module 118 provides the aggregated global model to the client nodes 116A, 116B, 116C. For the next one or more iterations of local training, the learning environment 120 of a client node 116 may use the aggregated parameters as a starting point for the training process of that iteration. The updated parameters of the encoder and the task model are received from the client nodes 116 to the distributed learning module 118 again for aggregation. This process is repeated until a certain criterion is reached.

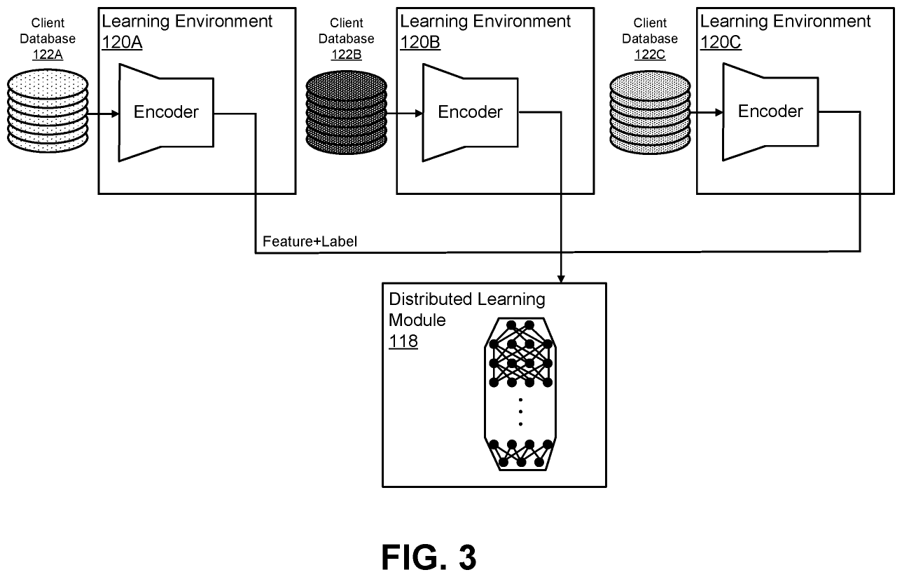

FIG. 3 illustrates a pipeline of the SL phase of the distributed learning framework, according to one embodiment. Specifically, during a SL phase of the pipeline, the distributed learning module 118 trains a server-side task model configured to perform a particular task (e.g., generate predictions for ADR's). The server-side task model may have a different or same architecture as the task neural network model trained locally by the client nodes 116 in the FL phase. However, the he server-side task model may be trained to perform a similar task as the task neural network model trained by the client nodes 116.

Specifically, the training data for training a server-side task model is received from the client nodes 116. The distributed learning module 118, from each client node 116, receives one or more data instances to train the server-side task model. A data instance includes a feature generated by applying the encoder for the client node 116 to a set of inputs (e.g., attributes extracted from a patient's medical history) obtained from client data and a respective label (e.g., the patient is known to have had an ADR to a drug or not). In the example shown in FIG. 3, the distributed learning module 118 receives one or more data instances from the learning environment 120A of the client node 116A. The features in these data instances were generated by applying the respective trained encoder of client node 116A to a set of inputs from client database 122A. The distributed learning module 118 also receives one or more data instances from learning environment 120B of client node 116B, and one or more data instances from learning environment 120C of client node 116C.

Specifically, during a SL phase of the pipeline, the distributed learning module 118 trains the server-side task model configured to perform a particular task (e.g., predict whether a patient will have an ADR to a drug or not). The server-side task model is coupled to receive a feature and generate an estimated prediction. The feature is an encoded version of a set of inputs that were generated by applying the set of inputs to a trained encoder for a client node 116. In one embodiment, the server-side task model has a different or same architecture as the task neural network model trained locally by the client nodes 116 in the FL phase. In one instance, the server-side task model is larger than the task neural network models trained locally during the FL phase at client nodes 116, with respect to the number of parameters. The server-side task model may also have a different architecture than the task neural network models. In this manner, the server-side task model may process vast amounts of data (e.g., feature and label instances) received from the client nodes 116.

In this manner, the distributed learning module 118 can train the server-side task model without exposing the raw set of inputs from various client databases 122 that make up the training data due to privacy and security concerns. Moreover, the distributed learning module 118 is able to make predictions on tasks using the trained server-side task model, even if only the encoded features are received from different client nodes 116 without the client nodes 116 having to expose the set of inputs. The distributed learning module 118 can thus effectively coordinate training of an encoder configured to generate a feature for a set of inputs even though the data distribution for client nodes 116 are heterogenous and syntactically different from one another, and obtain encoded features for training a server-side task model that is able to take into account data from the client nodes 116 of the system environment 100 for interoperable distributed learning.

The client nodes 116 may each correspond to a computing system (e.g., server) that manages health-related data for a respective institution or organization, such as a hospital, medical research facility, etc. The data stored for a client node 116 may be privacy-sensitive in that it includes electronic health or medical records for patients or subjects and may be subject to compliance with privacy laws and regulations (e.g., Health Insurance Portability and Accountability Act (HIPAA)) for protecting sensitive information. For example, client node 116A in the system environment 100 of FIG. 1 may correspond to a relatively small-sized clinic, client node 116B may correspond to a bio-medical research facility in a different geographical region than the clinic, and client node 116C may correspond to a large hospital.

The client data of a respective client node 116 may have one or more fields (e.g., patient ID, patient name, HAS-BLED scores), and values for those fields. The client data may be owned by an entity of the client node 116 in the sense that the entity may have control over exposure of the data, whether the data can be shared or accessed by other entities, and the like. The client data may be stored locally (e.g., on a local server, a private cloud, a disk on the client node 116) or may be stored on a cloud platform in a remote object datastore. As described above, each client node 116 may store their data according to a particular data schema. Therefore, while the client nodes 116 may collectively record information that describes the same or similar property (e.g., BMI) with one another, the way one institution encodes data may differ from the way another institution encodes the same or similar data with respect to the types of fields collected, vocabularies, categorization schemes, and the like.

While three example client nodes 116A, 116B, 116C are illustrated in the system environment 100 of FIG. 1, in practice many client nodes 116 may communicate with the systems in the environment 100. In one embodiment, a client node 116 is a conventional computer system, such as a desktop or laptop computer. Alternatively, a client node 116 may be a device having computer functionality, such as a personal digital assistant (PDA), a mobile telephone, a smartphone or another suitable device. A client node 116 is configured to communicate via the network 150.

The client nodes 116 and the learning system 110 are configured to communicate via the network 150, which may comprise any combination of local area and/or wide area networks, using both wired and/or wireless communication systems. In one embodiment, the network 150 uses standard communications technologies and/or protocols. For example, network 150 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 150 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 150 may be represented using any suitable format, such as hypertext markup language (HTML) or extensible markup language (XML). In some embodiments, all or some of the communication links of the network 150 may be encrypted using any suitable technique or techniques.

### Training Autoencoder and Task Neural Network Model Using Learning Environment of Client Node

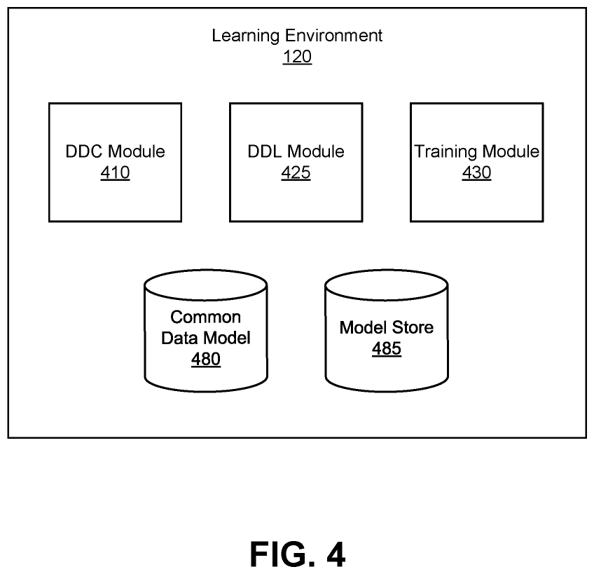

FIG. 4 illustrates a block diagram of an architecture of the learning environment 120 of a client node 116, according to one embodiment. The learning environment 120 shown in FIG. 4 includes a DDC module 410, a DDL module 425, and a training module 430. The learning environment 120 also includes a common data model datastore 480 and a model datastore 485. In other embodiments, the learning environment 120 may include additional, fewer, or different components for various applications. Conventional components such as network interfaces, security functions, load balancers, failover servers, management and network operations consoles, and the like are not shown so as to not obscure the details of the system architecture. Moreover, while not shown in FIG. 4, the learning environment 120 may have access to one or more databases managed by an entity of the client node 116.

The DDCM 410 may be deployed in the learning environment 120 of a client node 116 from the distributed learning module 118 of the learning system 110. In one embodiment, the DDCM 410 includes data pre-assessment toolkits and an ETL model. Responsive to receiving a request from the distributed learning module 118, the DDCM 410 executes a data pre-assessment using the pre-assessment toolkits on the client database. The DDCM 410 collects the statistics and abstract information from the client databases describing particular properties of the data. The DDCM 410 provides the collected statistics and abstract information to the distributed learning module 118.

In one instance, the statistics and abstract information collected by the DDCM 410 includes metadata like a list of table identifiers used to store the data, the number of fields in each table, or a number of records in the table. As another example, the metadata may include information on fields, such as unique values of a field or frequency distribution (e.g., range, min-max, average) of values for a field. The statistics and abstract information may also include which medical code system (e.g., ICD-10, KCD5) an entity (e.g., hospital, clinic, research facility) managing the client data encodes the data in, and a list of unique medical codes present in the client data. Thus, the statistics and abstract information may differ from one client node 116 to another, depending on the data schema used.

The DDCM 410 receives, from the distributed learning module 118, updated conversion logic and standardized vocabularies for application to the ETL model. The standardized vocabularies represent a set of vocabularies for encoding values for the data fields that should be used across the participating client nodes 116, since the master model will be trained based on the standardized vocabulary of values. The conversion logic is customized logic tailored to the client data of a respective client node 116 that includes instructions for performing one or more ETL operations to convert the client data to a target schema compatible with the local model to be trained. For example, the conversion logic may include logic for data field conversion that collects a set of fields and converts the fields into a target schema in the common data model store 480. As another example, the conversion logic may include conversion of a system of measurements (e.g., imperial to metric) or value bucketing conversions. As another example, the conversion logic may also include a set of mappings in the form of, for example, a mapping table (e.g., CSV file) that maps local vocabularies (e.g., local medical codes) to standardized medical codes (e.g., international medical codes) listed in the standardized vocabulary.

The DDCM 410 executes ETL operations to convert the client data to the common data model 480. In particular, the DDCM 410 extracts the client data from one or more data sources. The DDCM 410 transforms the data based on the conversion logic and standardized vocabulary received from the distributed learning module 118. The DDCM 410 loads the converted data to the common data model store 480, such that the converted data can be used to train the local model.

The DDLM 425 may also be deployed in the learning environment 120 of the client node 116 from the distributed learning module 118 of the learning system 110. In one embodiment, the DDLM 425 includes a base machine-learning model and software for data extraction and local model training. Specifically, the base machine-learning model may be a local copy of the master machine-learning model or at least a portion of the master model, in which parameters of the base model are not determined yet or have to be updated to reflect new updates in the training data. The DDLM 425 performs a training process to train the local model, such that the local model can be aggregated across the client nodes 116. The architecture of the local model may be used to perform any type of inference or generation tasks, including, but not limited to adverse drug reaction (ADR) predictions, cancer detection from images, cancer type classification, drug-to-drug interactions, disease prediction, patient stratification during clinical trials, drug efficacy predictions, and the like.

The DDLM 425 extracts a set of training data from the common data model 480 of the client node 116. The training data includes one or more instances of training inputs and outputs. The training inputs and outputs may have been converted from an original data source by the ETL operations performed by the DDCM 410. The DDLM 425 trains the local model with the extracted data. In one embodiment, the DDLM 425 may train the local model by repeatedly performing a forward pass step, a loss function determination step, and a backpropagation step. During the forward pass step, the training inputs are propagated through the local model to generate estimated outputs. During the loss function determination step, a loss function that indicates a difference (e.g., L2, L1 norm) between the estimated outputs and the corresponding training outputs is determined. During the backpropagation step, error terms from the loss function are used to update the parameters of the local model. These steps may be repeated multiple times using for example, different training batches, until a convergence criterion is reached. The DDLM 425 provides the distributed learning module 118 with the local model such that a consolidated master model can be generated.

In one embodiment, after the consolidation is performed across the client nodes 116, the DDLM 425 receives parameters of the consolidated master model from the distributed learning module 118. In this manner, the client node 116 can use the updated master model trained based on local data from other participating client nodes 116 to perform various types of health-related tasks (e.g., ADR predictions, disease diagnosis, etc.) without compromising the privacy of the local data from the other client nodes 116. For example, a master model for predicting ADR of patients may be provided to an institution that by itself, does not store sufficient data for training the ADR prediction model. The institution applies the master model to generate predictions for ADR for its patients without having to manually coordinate access to privacy-sensitive data of other institutions for training the ADR prediction model.

The training module 430 performs training of a global model received from the distributed learning module 118 for a FL phase. In one instance, the training module 430 receives a copy of a global model from the distributed learning module 118 and iterates between steps of training the global model based on local client data, providing the trained global model for the current communication round to the distributed learning module 118, and receiving an aggregated global model from the distributed learning module 118. This process is defined as a communication round. The training module 430 repeats these steps using the aggregated global model as the starting point for the next communication round. After a certain number of communication rounds, the training process is completed.

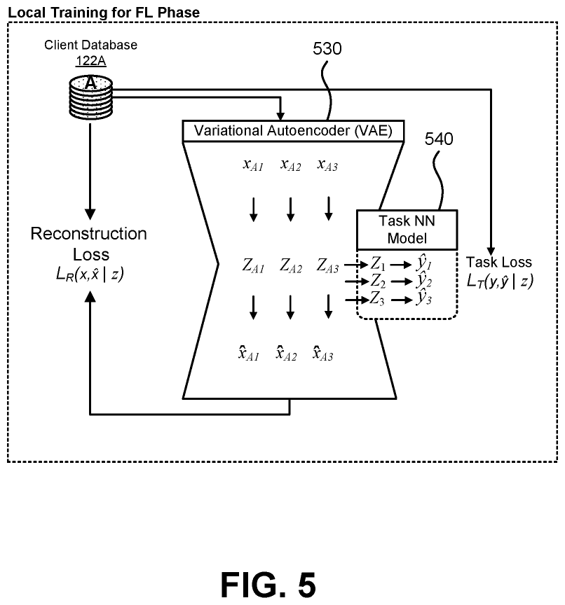

FIG. 5 is a training pipeline of a global model executed by a client node 116 within a distributed learning framework, according to one embodiment. In one embodiment, the copy of the global model includes an autoencoder-based architecture and a task neural network model. The example shown in FIG. 5 illustrates an example training process for a global model performed by the learning environment 120A at client node 116A. The global model includes an autoencoder 530 and a task neural network model 540. In one instance, the autoencoder is a variational autoencoder (VAE). However, it is appreciated that in other embodiments, the encoder of the disclosure herein may be an embedding model including bi-directional encoding representation transformer (BERT), Word2Vec, ELMo, and the like of an autoencoder or non-autoencoder architecture.

The autoencoder may include at least an encoder and a decoder. The encoder is coupled to receive input data and generate a latent representation (i.e., at a bottleneck layer of the autoencoder). The decoder is coupled to receive the latent representation and generate a reconstructed version of the input data. The task neural network model is coupled to receive a feature for the input data and generate a prediction for a task. In one instance, the feature input to the task neural network model is the output of the VAE encoder. However, it is appreciated that in other embodiments, the feature can be any intermediate output of any point within the autoencoder other than the output of the encoder.

The training module 430 obtains one or more data instances from the client database 122, which are training data for training the global model. For a data instance, the data instances includes a set of inputs and a corresponding label for the data instance that depends on the task the task neural network model (and eventually the server-side task model) is being trained for. For example, the desired task may be given the health and medical history for a health subject (e.g., patient), predict whether the patient will have an ADR to a particular drug in the future. In such an example, a data instance of the training data may include a set of inputs for a subject that include a list of medications taken, hospital visits, whether the subject experienced previous ADR's to other drugs, and a corresponding label indicating whether the subject experienced an ADR to the drug in question.

In one embodiment, the training module 430 performs one or more iterations of a training process to update parameters of the global model based on the training data. Specifically, the training module 430 iterations between a forward pass step and a parameter update step. For example, this may be a backpropagation step. The training module 430 initializes parameters of the encoder, decoder, and task neural network model.

During the forward pass step, the training module 430 applies the encoder of the autoencoder to the set of inputs to generate a latent representation. As shown in FIG. 5, a set of inputs x_{A1}, x_{A2}, x_{A3} for three data instances (e.g., for three different subjects) are obtained from the training data. After applying the encoder (with an estimated set of parameters), latent representations Z_{A1}, Z_{A2}, Z_{A3} are generated for each data instance. The training module 430 applies the decoder to the latent representation to generate a reconstructed version of the set of inputs. As shown in FIG. 5, a reconstructed version of the inputs \hat{x}_{A1}, \hat{x}_{A2}, \hat{x}_{A3} is generated for each data instance.

The training module 430 also applies the task neural network model to the features extracted from the set of inputs to generate one or more predictions. In the example shown in FIG. 5, the latent representations Z_{A1}, Z_{A2}, Z_{A3} are used as the features Z₁, Z₂, Z₃ to the task neural network model. After applying the task neural network model (with an estimated set of parameters), predictions ŷ₁, ŷ₂, ŷ₃ are generated for each data instance. Specifically, an estimated prediction may indicate an estimation for the task, for example, a likelihood that the subject of a respective data instance has an ADR to a particular drug.

The training module 430 determines a loss function for training the parameters of the autoencoder-based architecture and the task neural network model. In one embodiment, the loss function is a combination of a reconstruction loss L_{R}(x, \hat{x}|z) and a task-based loss L_{T}(y, ŷ|z). Specifically, for a given data instance, the reconstruction loss indicates a difference between the set of inputs x and the reconstructed version of the inputs \hat{x} output by the decoder given the latent representation. The task loss indicates a difference between the estimated prediction ŷ generated by the task neural network model and the label y for the data instance given the latent representation. In one instance, the reconstruction loss is given by:

L_{R}(x,\hat{x}|z)=∥x−\hat{x}∥² (1)

and the task loss is given by:

L_{T}(y,ŷ|z)=y·log ŷ+(1−y)·log(1−ŷ) (2)

when y is a binary label that is 1 if positive for task (e.g., positive ADR) and 0 if otherwise.

During the parameter update step, the training module 430 computes one or more error terms from the loss function. The training module 430 updates the parameters of the encoder, decoder, and task neural network model based on the computed error terms. In one embodiment, the training module 430 performs stochastic gradient descent to update the parameters based on the loss function. In one embodiment, the parameter update for one training iteration is given by:

[\hat{θ};\hat{ρ};\hat{ϕ}]→[θ;ρ;ϕ]−ηₜ·[∇_{θ}L_{R}+∇θL_{T};∇_{ρ}L_{R};∇_{ϕ}L_{T}] (3)

where θ, [symbol] , and φ respectively denote the parameters of the encoder, decoder, and task neural network model and ηₜ is the learning rate at iteration t.

Therefore, the parameters of the encoder θ are updated based on both the reconstruction loss and the task loss, while the parameters of the decoder [symbol] are updated based on the reconstruction loss, and parameters of the task neural network model φ are updated based on the task loss. For a given communication round, the training module 430 repeats one or more iterations of the training process. For example, in the subsequent iteration, a different batch of data instances many be used to compute the loss function and gradient updates.

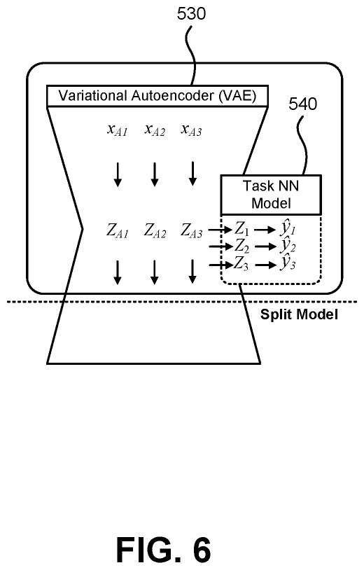

FIG. 6 illustrates splitting of the encoder and task neural network model for the global model, according to one embodiment. After local training iterations, the training module 430 splits the components of the global model and transmit gradients for the current communication round to the distributed learning module 118. In one embodiment, the training module 430 obtains gradients for the encoder of the autoencoder 530 and the task neural network model 540 and provides the gradients for the encoder and task neural network model to the distributed learning module 118. This is because gradients or parameters of the decoder can be used by an entity downstream to reverse-engineer an encoded feature to the raw set of inputs that potentially expose privacy-sensitive health information. Therefore, in one embodiment, the learning environment 120 of a client node 116 does not provide information related to the parameters of the decoder to the learning system 110 or another entity.

In one instance, the gradient for one communication round c at the FL phase may be given by:

$${g}_{t} = [ \tilde{θ} - {θ}_{c} ; \tilde{ϕ} - {ϕ}_{c} ] = {\sum }_{{t}^{′} = t}^{t + E} {η}_{t} \cdot {∇}_{{θ}_{{t}^{′}}} ( {L}_{R} + {L}_{T} ) ; {\sum }_{{t}^{′} = t}^{t + E} {η}_{t} \cdot {∇}_{{ϕ}_{{t}^{′}}} {L}_{T} \qquad ( 4 )$$

where t′ denotes the iteration at local training, E is the number of local training iterations, and θ_{c} are the parameters of the encoder and φ_{c} are the parameters of the task neural network model at the start of the communication round c. Moreover, [symbol] indicates the updated parameters of the encoder and the task neural network model for the current communication round in the particular client node 116.

The training module 430 provides the gradient g t to the distributed learning module 118. For the next communication round, the training module 430 receives an aggregated set of parameters for the encoder and the task neural network model from the distributed learning module 118 after the distributed learning module 118 has aggregated the gradients (or other forms of update to parameters) across the different client nodes 116. In one instance, the parameters received by the training module 430 for the next communication round c+1 may be given by:

$$[ \tilde{θ} ; \tilde{ϕ} ] ← [ θ ; ϕ ] - {\sum }_{n = 1}^{N} {η}_{t} \cdot {g}_{t}^{n} \qquad ( 5 )$$

where \tilde{θ} denote the aggregated parameters of the encoder and \tilde{ϕ} denote the aggregated parameters of the task neural network model. In one instance, the parameters may correspond to the parameters of the encoder θ_{c+1} and the parameters of the task neural network model φ_{c+1} for the start of the next communication round. The training module 430 may repeat the local training for the next communication round and provide the updates again to the distributed learning module 118.

In this manner, the training module 430 participates in federated learning of parameters of the encoder and the task neural network model in conjunction with the distributed learning module 118 over one or more communication rounds. Therefore, after training, the learning environment 120 at a client node 116 stores a trained encoder, a decoder, and a task neural network model. The trained encoder is configured to receive a set of inputs from the client store 122 and generate a feature representing the set of inputs in the common latent space. Moreover, since the encoder was trained in a federated learning framework in coordination with the gradients received from other client nodes 116, the encoder when executed with a set of inputs from another client node 116 is also configured to generate another feature representing those inputs in the same latent space. The trained decoder is configured to receive a latent representation and generate a reconstructed version of the underlying set of inputs, resembling the schema of the client node 116. The trained task neural network model is configured to receive a feature and generate one or more predictions for the task.

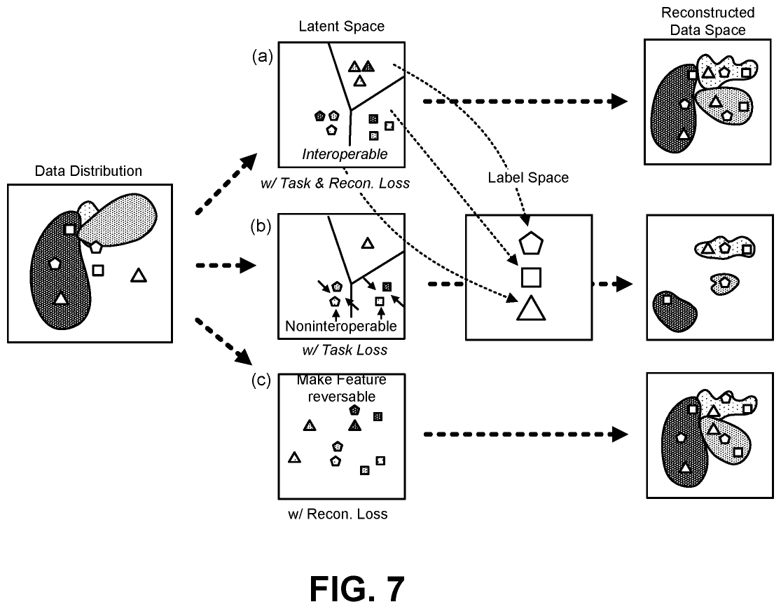

FIG. 7 illustrates comparisons of a latent space and a reconstructed data space with different federated learning frameworks trained with a task loss and/or a reconstruction loss, according to one embodiment. Each institution has a data point that should be classified to a first label (e.g., triangle shape), a data point that should be classified to a second label (e.g., square shape), and a data point that should be classified to a third label (e.g., pentagon shape). An institution A may train Model A, institution B may train Model B, and institution C may train Model C, respectively, each with its own data. However, a model for a particular institution is not interoperable with data from other institutions because of heterogeneity.

The example shown in FIG. 7 illustrates the latent space (mapped by a trained encoder) and reconstructed data space (as mapped by a trained decoder) with different federated learning frameworks trained with (a) a proposed loss that is a combination of a task loss and a reconstruction loss, (b) a task loss alone, (c) and a reconstruction loss alone. The markers in the latent space depict the latent representations that can be reversed and decoded to the original set of inputs. As illustrated in FIG. 4(b), reducing the task loss alone can reduce the distance between points with the same classes in the latent space. On the other hand, the reconstruction loss can preserve the original information of the datasets. Thus, the number of markers in FIG. 4(c) is larger than the ones in FIG. 4(b) as one goal of the reconstruction loss is to retain as much information as possible while the task loss is focused more on discriminating power. Thus, in one embodiment, the interoperable distributed learning approach described herein combines both the task loss and the reconstruction loss to have a common latent space, as shown in FIG. 4(a).

After the FL phase, the training module 430 identifies a set of data instances that will contribute to training the server-side task model by the distributed learning module 118. In particular, the training module 430 applies the trained encoder to the set of inputs for each of the identified data instances to generate features for these data instances. The training module 430 collects the features and labels for the data instances and transmits the pairs to the distributed learning module 118.

### Training Server-Side Task Model Using Learning System

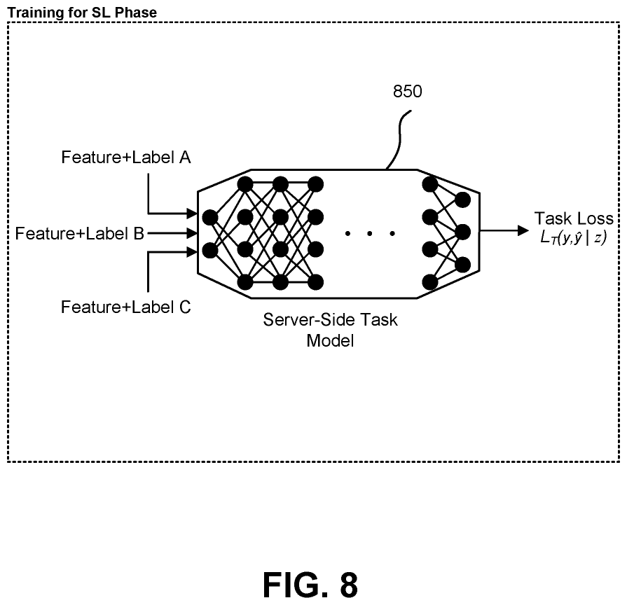

FIG. 8 is a training pipeline of a server-side task model 850 executed by a distributed learning module of a learning system, according to one embodiment. After the FL phase, the distributed learning module 118 trains the server-side task model based on feature and label pairs obtained from the client nodes 116. The distributed learning module stores the feature-labels in the learning store 112. In other words, the feature-labels may be given by S(Z, Y)=Uₙ₌₁^{N}{p_{Φ}(zₙ|xₙ), yₙ}, where n denotes the client node 116, xₙ is a set of inputs for a data instance from client node 116, yₙ is the label for the data instance, zₙ is the feature generated by inputting the set of inputs xₙ to the trained encoder, and Φ are the parameters of the server-side task model.

The distributed learning module 118 trains parameters of the server-side task model by iterating between a forward pass step and a parameter update step. During the forward pass step, the distributed learning module 118 applies estimated parameters of the server-side task model to the features to generate estimated predictions for those features. In the example shown in FIG. 8, the feature-labels received from institution A, institution B, and institution C can be used to generate estimated predictions for each data instance. The distributed learning module 118 computes a loss function that indicates a difference between the labels and the estimated predictions. The distributed learning module 118 computes one or more error terms from the loss function. During the parameter update step, the distributed learning module 118 updates parameters of the server-side task model using the error terms to reduce the loss function.

In one instance, the parameter update is given by:

$$\tilde{Φ} ← Φ - {η}_{t} \cdot {\sum }_{( z , y ) ∈ S ( Z , Y )} {∇}_{Φ} {L}_{T} \qquad ( 6 )$$

where ηₜ is the learning rate, L_{T} is the task loss for the server-side task model, and Φ are the parameters of the server-side task model. This process is repeated for one or more iterations until a convergence criterion is reached. For a next communication round, the distributed learning module 118 may receive a new batch of feature-label pairs from the client nodes 116 and repeat the training process to further update the parameters.

In one embodiment, the local gradient information is not conveyed to the distributed learning module 118 from the local learning environments 120 in the split learning phase, but rather feature-labels for data instances are transmitted to the distributed learning module 118. For example, rather than having the client nodes 116 train a copy of the server-side task model and transmit gradients for the model to the distributed learning module 118, the client nodes 116 transmit feature-labels alone because it saves communication costs and preserves data privacy. Transmitting the gradients to the distributed learning module 118 can be computationally cumbersome and slow especially when the number of parameters is large, and thus, transmitting the feature-labels without the gradient may save communication costs without compromising data privacy.

After training the server-side task model, the distributed learning module 118 performs inference with new data instances from client nodes 116. Specifically, a set of inputs for the data instance may be encoded as a feature by applying the trained encoder. Alternatively, the feature may correspond to an output of any intermediate layer of the trained autoencoder. The distributed learning module 118 applies the trained server-side task model to the feature to generate an estimated prediction (e.g., likelihood of ADR) and may provide the prediction to the client node 116. Alternatively, the distributed learning module 118 provides the client nodes 116 with copies of the server-side task model, such that the learning environment 120 of each client node 116 can use the server-side task model (coupled with the trained encoder) for inference.

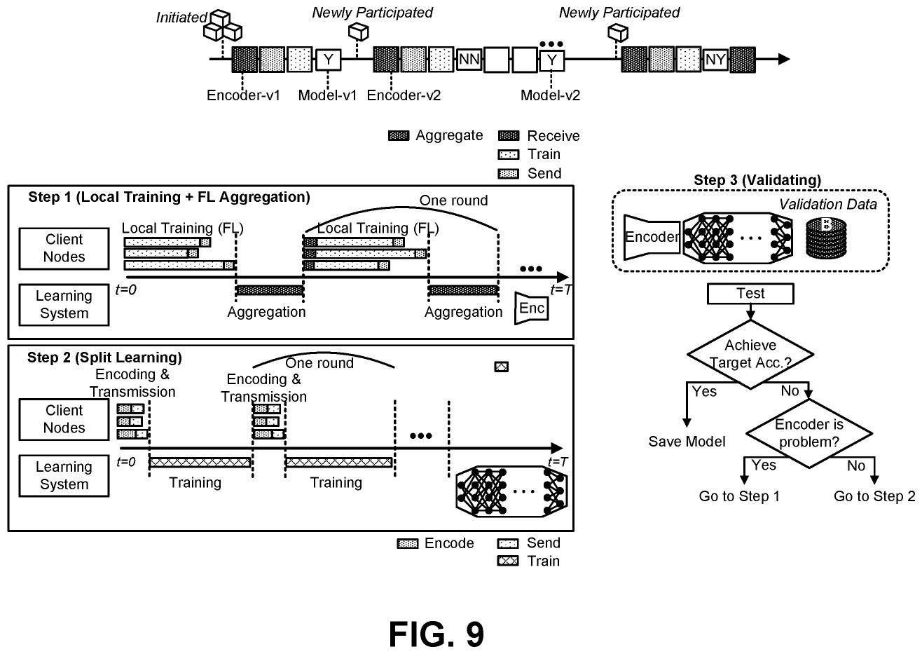

In one embodiment, to manage the version of the global model, an additional validation process can be performed. During the validation phase, the distributed learning module 118 validates the server-side task model with validation data. If the validation accuracy is higher than the target accuracy, it stores the server-side task model for future inference. Otherwise, it diagnoses whether the problem originated in the encoder or server-side task model. If the problem is tracked to the encoder, the FL phase (“Step 1” in FIG. 9) is addressed to correct any issues arising from training the encoder. Similarly, if the problem is tracked to the server-side task model, the SL phase (“Step 2” in FIG. 9) is addressed to correct any issues arising from training the server-side task model.

FIG. 9 is an overall pipeline of the distributed learning framework including the FL phase, the SL phase, and the validation phase, according to one embodiment. In one embodiment, as shown in FIG. 9, the learning system 110 and client nodes 116 repeatedly iterate through the FL phase, the SL phase, and the validation phase as new data becomes available (at client or server side), and/or as new participants are added to the interoperable distributed learning environment 100. In this manner, new data or new participants can be effectively and efficiently added to the environment as they become available.

Step 1 illustrates the local training and FL aggregation that occurs during the FL phase. The horizontal axis indicates time, and the bars indicate training time, receive transmission time, send transmission time as indicated in the legend. The example of FIG. 9 illustrates a scenario where there are three participants (three client nodes 116). As shown in FIG. 9, when training the autoencoder and task neural network models, the client nodes 116 for a communication round spend most time training parameters of the autoencoder and the task neural network model. The client nodes 116 also spend a shorter amount of time transmitting the parameters of the encoder and the task neural network model to the learning system 110 or receiving the aggregated parameters from the learning system 110. The learning system 110 spends time obtaining gradient updates (or parameter values) and aggregating the gradient updates (or parameter values). The learning system 110 provides the aggregated parameters to the client nodes 116.

Step 2 illustrates the training that occurs during the SL phase. The bars indicate training time and send transmission time, as indicated in the legend. The horizontal axis is time, and the bars indicate encoding time, send transmission time, and training time as indicated in the legend. As shown in FIG. 9, when training the server-side task model, the client nodes 116 for a communication round spend time encoding the set of inputs for one or more data instances to features using the encoder and transmitting the feature-label pairs to the learning system 110. The learning system 110 spends time training the server-side task model based on the received feature-label pairs.

Step 3 illustrates the validation phase. As shown in FIG. 9, in one embodiment, the learning system 110 further validates the server-side task model to address any issues that arise during, for example, training of the encoder and training of the server-side task model.

### Example Implementations

The proposed interoperable distributed learning framework can be applied to various applications, such as image classifications, natural language understandings, clinical data classification, and the like, particularly, where available datasets are heterogeneous in terms of data distributions or syntactic representations. For example, the environment can be used in applications where machine learning models are trained from multiple hospitals that use different medical codes. In this scenario, although even the same medical events can be represented with different codes, the proposed framework can train interoperable models without manual data conversion. The proposed framework can also be used in applications where datasets are from a children's hospital (or, a senior hospital) and general hospitals that have different data distributions regarding not only age categories but also types of disease. The framework is capable of generating features within a common latent feature space so that the trained model can be used across different hospitals.

Configuration of the model including how many layers for each party can be adjusted depending on applications and given requirements. For example, if the computing power of clients is limited, the split can be configured to reduce or minimize the number of layers for clients, and vice versa. In particular, under the consideration of computing and communication resources, lightweight neural networks can be used as local models. In one embodiment, the parameters of the task neural network model is less than 10% o f the number of parameters of the server-side task model that achieves high performance and requires high computation cost. Table 1 shows some example models that can be implemented using the proposed framework. In addition, neural network with fewer parameters is known to achieve faster convergence in the training process. Thus, the computing and communication resources are significantly reduced.

TABLE 1
The model used as server and clients.

| | Original Model | Task Neural Network Model |
|---|---|---|
| Tasks/Model | (Server) | (Client) |
| Image Classification | RESNET50 | RESNET8 |
| NLP | BERT | BERT-MINI |

### Method for Distributed Training of a Global Model and a Server-Side Task Model

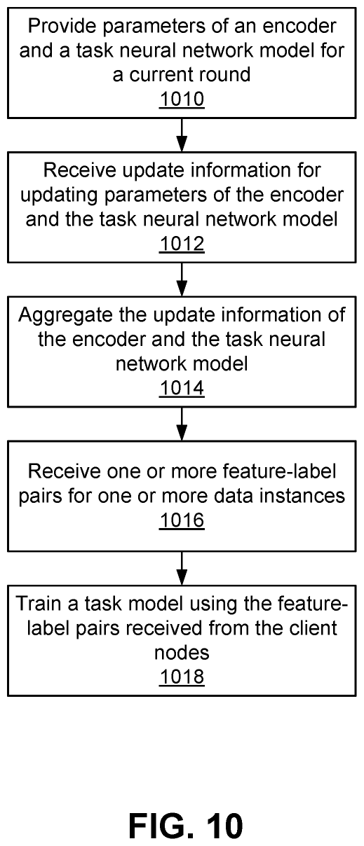

FIG. 10 is an example flowchart for distributed training of a global model and a server-side task model, according to one embodiment. For one or more rounds, the learning system 110 provides 1010, to each client node, parameters of an encoder of an autoencoder and a task neural network model for a current round. The encoder may be configured to receive a set of inputs and generate a feature in a latent space, and the task neural network model may be configured to receive the feature and generate an estimated label. The learning system 110 receives 1012, from each client node, update information for updating the parameters of the encoder and the task neural network model from the client node. The update information for the encoder and the task neural network model from the client node are obtained using a subset of the client data for the current round. The learning system 110 aggregates 1014 the update information of the encoder and the task neural network model received from the one or more client nodes. The learning system 110 receives 1016, from each client node, one or more feature-label pairs for one or more data instances, wherein a feature for a data instance is generated by applying the encoder for the client node to a set of inputs for the data instance. The learning system 110 trains 1018 a task model using the feature-label pairs received from the one or more client nodes.

### SUMMARY

The foregoing description of the embodiments of the disclosed configuration has been presented for the purpose of illustration; it is not intended to be exhaustive or to limit the disclosed configuration to the precise forms disclosed. Persons skilled in the relevant art can appreciate that many modifications and variations are possible in light of the above disclosure.

Some portions of this description describe the embodiments of the disclosed configuration in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosed configuration may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the disclosed configuration may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosed configuration be limited not by this detailed description, but rather by any claims that issue on an application based hereon. Accordingly, the disclosure of the embodiments of the disclosed configuration is intended to be illustrative, but not limiting, of the scope of the disclosed configuration, which is set forth in the following claims.

What is claimed is:

1. A method, comprising:
for one or more rounds:
providing, to each client node, parameters of an encoder of an autoencoder and a task neural network model for a current round, wherein the encoder is configured to receive a set of inputs and generate a feature in a latent space, and wherein the task neural network model is configured to receive the feature and generate an estimated label,
receiving, from each client node, update information for updating the parameters of the encoder and the task neural network model from the client node, wherein the update information for the encoder and the task neural network model from the client node are obtained using a subset of the client data for the current round, and
aggregating the update information of the encoder and the task neural network model received from the one or more client nodes;
receiving, from each client node, one or more feature-label pairs for one or more data instances, wherein a feature for a data instance is generated by applying the encoder for the client node to a set of inputs for the data instance; and
training a task model using the feature-label pairs received from the one or more client nodes.

2. The method of claim 1, wherein a number of parameters of the task model is larger than a number of parameters of the task neural network model.

3. The method of claim 1, wherein the update information received from the client node does not include information for updating parameters of a decoder of the autoencoder trained in conjunction with the encoder.

4. The method of claim 1, wherein the client data for a first client node is stored according to a first schema and the client data for a second client node is stored according to a second schema different from the first schema.

5. The method of claim 1, further comprising setting aggregated parameters of the encoder and the task neural network as the parameters for the next round.

6. The method of claim 1, wherein the update information of the encoder and the task neural network model received from the client node is obtained by:
applying the encoder to a training set of inputs to generate a feature for the training set of inputs,
applying a decoder of the autoencoder to the feature to generate a reconstructed version of the training set of inputs,
applying the task neural network model to the feature to generate an estimated prediction; and
backpropagating error terms obtained from a loss function including a task loss and a reconstruction loss, the task loss indicating a difference between the estimated prediction and a label for the training set of inputs, the reconstruction loss indicating a difference between the reconstructed version of the training set of inputs and the training set of inputs.

7. The method of claim 1, wherein the update information is at least one of updated values of the parameters of the encoder and the task neural network model or gradient updates to the parameters of the encoder and the task neural network model.

8. A non-transitory computer readable medium comprising stored instructions, the stored instructions when executed by at least one processor of one or more computing devices, cause the one or more computing devices to:
for one or more rounds:
provide, to each client node, parameters of an encoder of an autoencoder and a task neural network model for a current round, wherein the encoder is configured to receive a set of inputs and generate a feature in a latent space, and wherein the task neural network model is configured to receive the feature and generate an estimated label,
receive, from each client node, update information for updating the parameters of the encoder and the task neural network model from the client node, wherein the update information for the encoder and the task neural network model from the client node are obtained using a subset of the client data for the current round, and
aggregate the update information of the encoder and the task neural network model received from the one or more client nodes;
receive, from each client node, one or more feature-label pairs for one or more data instances, wherein a feature for a data instance is generated by applying the encoder for the client node to a set of inputs for the data instance; and
train a task model using the feature-label pairs received from the one or more client nodes.

9. The non-transitory computer readable medium of claim 8, wherein a number of parameters of the task model is larger than a number of parameters of the task neural network model.

10. The non-transitory computer readable medium of claim 8, wherein the update information received from the client node does not include information for updating parameters of a decoder of the autoencoder trained in conjunction with the encoder.

11. The non-transitory computer readable medium of claim 8, wherein the client data for a first client node is stored according to a first schema and the client data for a second client node is stored according to a second schema different from the first schema.

12. The non-transitory computer readable medium of claim 8, the stored instructions further causing the one or more computing devices to set aggregated parameters of the encoder and the task neural network as the parameters for the next round.

13. The non-transitory computer readable medium of claim 8, wherein the update information of the encoder and the task neural network model received from the client node is obtained by:
applying the encoder to a training set of inputs to generate a feature for the training set of inputs,
applying a decoder of the autoencoder to the feature to generate a reconstructed version of the training set of inputs,
applying the task neural network model to the feature to generate an estimated prediction; and
backpropagating error terms obtained from a loss function including a task loss and a reconstruction loss, the task loss indicating a difference between the estimated prediction and a label for the training set of inputs, the reconstruction loss indicating a difference between the reconstructed version of the training set of inputs and the training set of inputs.

14. The non-transitory computer readable medium of claim 8, wherein the update information is at least one of updated values of the parameters of the encoder and the task neural network model or gradient updates to the parameters of the encoder and the task neural network model.

15. A computer system comprising:
one or more computer processors; and
one or more computer readable mediums storing instructions that, when executed by the one or more computer processors, cause the computer system to:
for one or more rounds:
provide, to each client node, parameters of an encoder of an autoencoder and a task neural network model for a current round, wherein the encoder is configured to receive a set of inputs and generate a feature in a latent space, and wherein the task neural network model is configured to receive the feature and generate an estimated label,
receive, from each client node, update information for updating the parameters of the encoder and the task neural network model from the client node, wherein the update information for the encoder and the task neural network model from the client node are obtained using a subset of the client data for the current round, and
aggregate the update information of the encoder and the task neural network model received from the one or more client nodes;
receive, from each client node, one or more feature-label pairs for one or more data instances, wherein a feature for a data instance is generated by applying the encoder for the client node to a set of inputs for the data instance; and
train a task model using the feature-label pairs received from the one or more client nodes.

16. The computer system of claim 15, wherein a number of parameters of the task model is larger than a number of parameters of the task neural network model.

17. The computer system of claim 15, wherein the update information received from the client node does not include information for updating parameters of a decoder of the autoencoder trained in conjunction with the encoder.

18. The computer system of claim 15, wherein the client data for a first client node is stored according to a first schema and the client data for a second client node is stored according to a second schema different from the first schema.

19. The computer system of claim 15, the stored instructions further causing the one or more computing devices to set aggregated parameters of the encoder and the task neural network as the parameters for the next round.

20. The computer system of claim 15, wherein the update information of the encoder and the task neural network model received from the client node is obtained by:
applying the encoder to a training set of inputs to generate a feature for the training set of inputs,
applying a decoder of the autoencoder to the feature to generate a reconstructed version of the training set of inputs,
applying the task neural network model to the feature to generate an estimated prediction; and
backpropagating error terms obtained from a loss function including a task loss and a reconstruction loss, the task loss indicating a difference between the estimated prediction and a label for the training set of inputs, the reconstruction loss indicating a difference between the reconstructed version of the training set of inputs and the training set of inputs.
